(19) United States
(12) Patent Application Publication
(10) Pub. No.: US 2015/0382083 A1
(43) Pub. Date: Dec. 31, 2015

(54) PICTORIAL SUMMARY FOR VIDEO

(71) Applicants: Zhibo CHEN, Beijing (CN); Debing LIU, Beijing (CN); Xiaodong GU, Beijing (CN); Fan ZHANG, Wuhan, Hubei (CN)

(72) Inventors: ZHIBO CHEN, BEIJING (CN); DEBING LIU, BEIJING (CN); XIAODONG GU, BEIJING (CN); FAN ZHANG, WUHAN HUBEI (CN)

(73) Assignee: Thomson Licensing, Issy de Moulineaux (FR)

(21) Appl. No.: 14/770,071

(22) PCT Filed: Mar. 6, 2013
(86) PCT No.: PCT/CN2013/072253

§ 371 Date: Aug. 24, 2015

(51) Int. Cl. H04N 21/8549

(52) U.S. Cl. CPC H04N 21/8549

(57) ABSTRACT

Various implementations relate to providing a pictorial summary, also referred to as a comic book or a narrative abstraction. In one particular implementation, a first portion in a video is accessed, and a second portion in the video is accessed. A weight for the first portion is determined, and a weight for the second portion is determined. A first number and a second number are determined. The first number identifies how many pictures from the first portion are to be used in a pictorial summary of the video. The first number is one or more, and is determined based on the weight for the first portion. The second number identifies how many pictures from the second portion are to be used in the pictorial summary of the video. The second number is one or more, and is determined based on the weight for the second portion.

### TECHNICAL FIELD

Implementations are described that relate to a pictorial summary of a video. Various particular implementations relate tousing a configurable, fine-grain, hierarchical, scene-based analysis to create a pictorial summary of a video.

### BACKGROUND

Video can often be long, making it difficult for a potential user to determine what the video contains and to determine whether the user wants to watch the video. Various tools exist to create a pictorial summary, also referred to as a story book or a comic book or a narrative abstraction. The pictorial summary provides a series of still shots that are intended to summarize or represent the content of the video. There is a continuing need to improve the available tools for creating a pictorial summary, and to improve the pictorial summaries that are created.

### SUMMARY

According to a general aspect, a first portion in a video is accessed, and a second portion in the video is accessed. A weight for the first portion is determined, and a weight for the second portion is determined. A first number and a second number are determined. The first number identifies how many pictures from the first portion are to be used in a pictorial summary of the video. The first number is one or more, and is determined based on the weight for the first portion. The second number identifies how many pictures from the second portion are to be used in the pictorial summary of the video. The second number is one or more, and is determined based on the weight for the second portion.

The details of one or more implementations are set forth in the accompanying drawings and the description below. Even if described in one particular manner, it should be clear that implementations may be configured or embodied in various manners. For example, an implementation may be performed as a method, or embodied as an apparatus, such as, for example, an apparatus configured to perform a set of operations or an apparatus storing instructions for performing a set of operations, or embodied in a signal. Other aspects and features will become apparent from the following detailed description considered in conjunction with the accompanying drawings and the claims.

### BRIEF DESCRIPTION OF THE DRAWINGS

FIG. 1 provides an example of a hierarchical structure for a video sequence.

FIG. 2 provides an example of an annotated script, or screenplay.

FIG. 3 provides a flow diagram of an example of a process for generating a pictorial summary.

FIG. 4 provides a block diagram of an example of a system for generating a pictorial summary.

FIG. 5 provides a screen shot of an example of a user interface to a process for generating a pictorial summary.

FIG. 6 provides a screen shot of an example of an output page from a pictorial summary.

FIG. 7 provides a flow diagram of an example of a process for allocating pictures in a pictorial summary to scenes.

FIG. 8 provides a flow diagram of an example of a process for generating a pictorial summary based on a desired number of pages.

FIG. 9 provides a flow diagram of an example of a process for generating a pictorial summary based on a parameter from a configuration guide.

### DETAILED DESCRIPTION

Pictorial summaries can be used advantageously in many environments and applications, including, for example, fast video browsing, media bank previewing or media library previewing, and managing (searching, retrieving, etc.) user-generated and/or non-user-generated content. Given that the demands for media consumption are increasing, the environments and applications that can use pictorial summaries are expected to increase.

Pictorial summary generating tools can be fully automatic, or allow user input for configuration. Each has its advantages and disadvantages. For example, the results from a fully automatic solution are provided quickly, but might not be appealing to a broad range of consumers. In contrast, however, complex interactions with a user-configurable solution allow flexibility and control, but might frustrate novice consumers. Various implementations are provided in this application, including implementations that attempt to balance automatic operations and user-configurable operations. One implementation provides the consumer with the ability to customize the pictorial summary by specifying a simple input of the number of pages that are desired for the output pictorial summary.

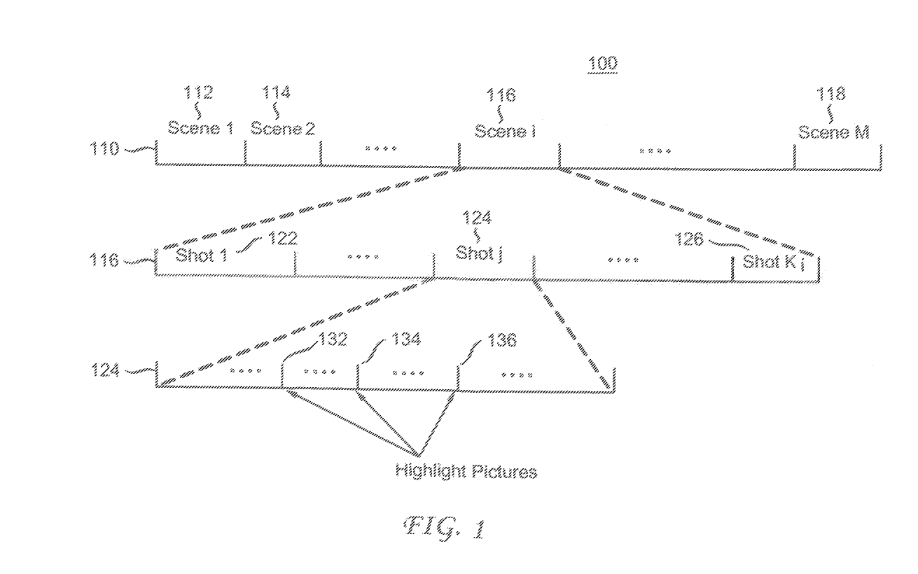

Referring to FIG. 1, a hierarchical structure 100 is provided for a video sequence 110. The video sequence 110 includes a series of scenes, with FIG. 1 illustrating a Scene 1 112 beginning the video sequence 110, a Scene 2 114 which follows the Scene 1 112, a Scene i 116 which is a scene at an unspecified distance from the two ends of the video sequence 110, and a Scene M 118 which is the last scene in the video sequence 110.

The Scene i 116 includes a series of shots, with the hierarchical structure 100 illustrating a Shot 1 122 beginning the Scene i 116, a Shot j 124 which is a shot at an unspecified distance from the two ends of the Scene i 116, and a Shot Kᵢ 126 which is the last shot in the Scene i 116.

The Shot j 124 includes a series of pictures. One or more of these pictures is typically selected as a highlight picture (often referred to as a highlight frame) in a process of forming a pictorial summary. The hierarchical structure 100 illustrates three pictures being selected as highlight pictures, including a first highlight picture 132, a second highlight picture 134, and a third highlight picture 136. In a typical implementation, selection of a picture as a highlight picture also results in the picture being included in the pictorial summary.

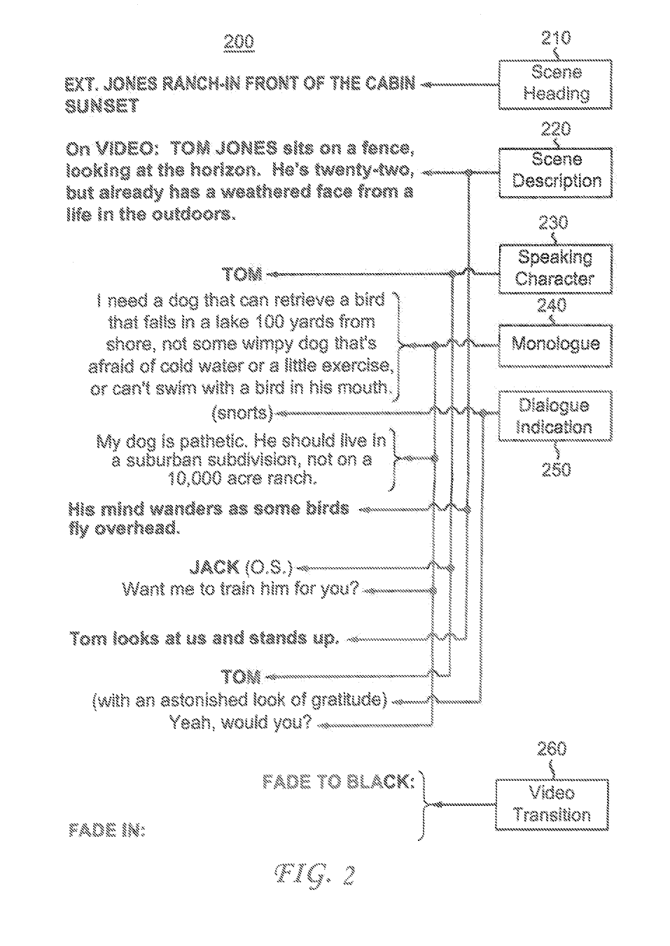

Referring to FIG. 2, an annotated script, or screenplay, 200 is provided. The script 200 illustrates various components of a typical script, as well as the relationships between the components. A script can be provided in a variety of forms, including, for example, a word processing document.

A script or screenplay is frequently defined as a written work by screenwriters for a film or television program. In a script, each scene is typically described to define, for example, “who” (character or characters), “what” (situation), “when” (time of day), “where” (place of action), and “why” (purpose of the action). The script 200 is for a single scene, and includes the following components, along with typical definitions and explanations for those components:
1. Scene Heading: A scene heading is written to indicate a new scene start, typed on one line with some words abbreviated and all words capitalized. Specifically, the location of a scene is listed before the time of day when the scene takes place. Interior is abbreviated INT. and refers, for example, to the inside of a structure. Exterior is abbreviated EXT. and refers, for example, to the outdoors.
   The script 200 includes a scene heading 210 identifying the location of the scene as being exterior, in front of the cabin at the Jones ranch. The scene heading 210 also identifies the time of day as sunset.
2. Scene Description: A scene description is a description of the scene, typed across the page from the left margin toward the right margin. Names of characters are displayed in all capital letters the first time they are used in a description. A scene description typically describes what appears on the screen, and can be prefaced by the words “On VIDEO” to indicate this.
   The script 200 includes a scene description 220 describing what appears on the video, as indicated by the words “On VIDEO”. The scene description 220 includes three parts. The first part of the scene description 220 introduces Tom Jones, giving his age (“twenty-two”), appearance (“a weathered face”), background (“a life in the outdoors”), location (“on a fence”), and current activity (“looking at the horizon”).
   The second part of the scene description 220 describes Tom's state of mind at a single point in time (“mind wanders as some birds fly overhead”). The third part of the scene description 220 describes actions in response to Jack's offer of help (“looks at us and stands up”).
3. Speaking character: All capital letters are used to indicate the name of the character that is speaking.
   The script 200 includes three speaking character indications 230. The first and third speaking character indications 230 indicate that Tom is speaking. The second speaking character indication 230 indicates that Jack is speaking, and also that Jack is off-screen (“O.S.”), that is, not visible in the screen.
4. Monologue: The text that a character is speaking is centered on the page under the characters name, which is in all capital letters as described above.
   The script 200 includes four sections of monologue, indicated by a monologue indicator 240. The first and second sections are for Tom's first speech describing the problems with Tom's dog, and Tom's reaction to those problems. The third section of monologue is Jack's offer of help (“Want me to train him for you?”). The fourth section of monologue is Tom's reply (“Yeah, would you?”).
5. Dialogue indication: A dialogue indication describes the way that a character looks or speaks before the character's monologue begins or as it begins. This dialogue indication is typed below the characters name, or on a separate line within the monologue, in parentheses.
   The script 200 includes two dialogue indications 250. The first dialogue indication 250 indicates that Tom “snorts”. The second dialogue indication 250 indicates that Tom has an astonished look of gratitude”.
6. Video transition: A video transition is self-explanatory, indicating a transition in the video.
   The script 200 includes a video transition 260 at the end of the scene that is displayed. The video transition 260 includes a fade to black, and then a fade-in for the next scene (not shown).

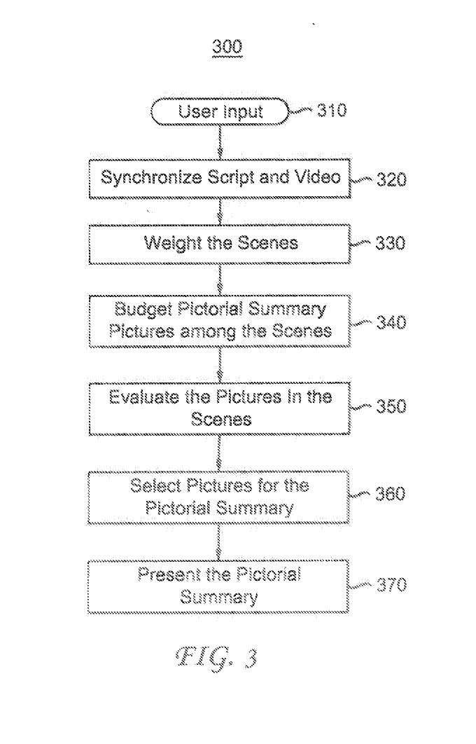

FIG. 3 provides a flow diagram of an example of a process 300 for generating a pictorial summary. The process 300 includes receiving user input (310). Receiving user input is an optional operation because, for example, parameters can be fixed and not require selection by a user. However, the user input, in various implementations, includes one or more of:
(i) information identifying a video for which a pictorial summary is desired, including, for example, a video file name, a video resolution, and a video mode,
(ii) information identifying a script that corresponds to the video, including, for example, a script file name,
(iii) information describing the desired pictorial summary output, including, for example, a maximum number of pages desired for the pictorial summary, a size of the pages in the pictorial summary, and/or formatting information for the pages of the pictorial summary (for example, sizes for gaps between pictures in the pictorial summary),
(iv) a range of the video to be used in generating the pictorial summary,
(v) parameters used in scene weighting, such as, for example, (i) any of the parameters discussed in this application with respect to weighting, (ii) a name of a primary character to emphasize in the weighting (for example, James Bond), (iii) a value for the number of main characters to emphasize in the weighting, (iv) a list of highlight actions or objects to emphasize in the weighting (for example, the user may principally be interested in the car chases in a movie),
(vi) parameters used in budgeting the available pages in a pictorial summary to the various portions (for example, scenes) of the video, such as, for example, information describing a maximum number of pages desired for the pictorial summary,
(vii) parameters used in evaluating pictures in the video, such as, for example, parameters selecting a measure of picture quality, and/or
(viii) parameters used in selecting pictures from a scene for inclusion in the pictorial summary, such as, for example, a number of pictures to be selected per shot.

The process 300 includes synchronizing (320) a script and a video that correspond to each other. For example, in typical implementations, the video and the script are both for a single movie. At least one implementation of the synchronizing operation 320 synchronizes the script with subtitles that are already synchronized with the video. Various implementations perform the synchronization by correlating the text of the script with the subtitles. The script is thereby synchronized with the video, including video timing information, through the subtitles. One or more such implementations perform the script-subtitle synchronization using known techniques, such as, for example, dynamic time warping methods as described in M. Everingham, J. Sivic, and A. Zisserman, “‘Hello! My name is . . . Buffy.’ Automatic Naming of Characters in TV Video”, in Proc. British Machine Vision Conf., 2006 (the “Everingham” reference). The contents of the Everingham reference are hereby incorporated by reference in their entirety for all purposes, including, but not limited to, the discussion of dynamic time warping.

The synchronizing operation 320 provides a synchronized video as output. The synchronized video includes the original video, as well as additional information that indicates, in some manner, the synchronization with the script. Various implementations use video time stamps by, for example, determining the video time stamps for pictures that correspond to the various portions of a script, and then inserting those video time stamps into the corresponding portions of the script.

The output from the synchronizing operation 320 is, in various implementations, the original video without alteration (for example, annotation), and an annotated script, as described, for example, above. Other implementations do alter the video instead of, or in addition to, altering the script. Yet other implementations do not alter either the video or the script, but do provide synchronizing information separately. Still, further implementations do not even perform synchronization.

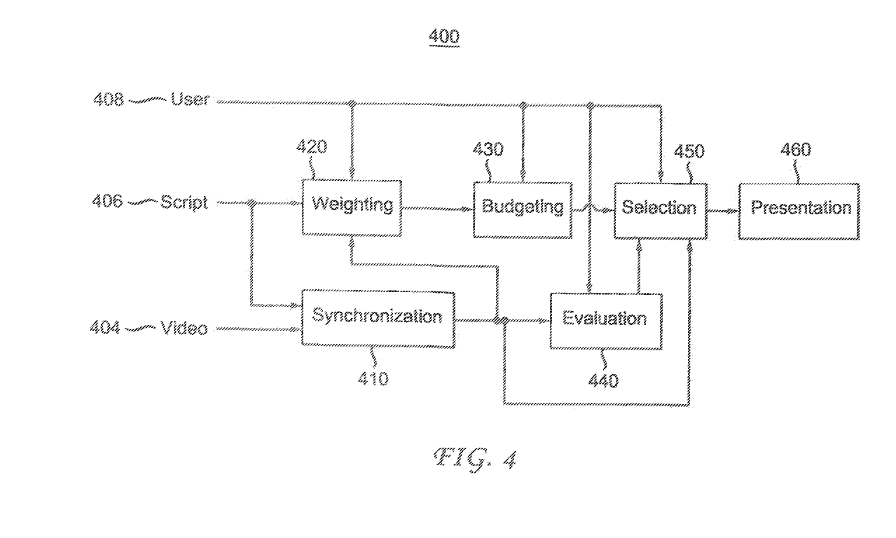

The process 300 includes weighting one or more scenes in the video (330). Other implementations weight a different portion of the video, such as, for example, shots, or groups of scenes. Various implementations use one or more of the following factors in determining the weight of a scene:
1. The starting scene in the video, and/or the ending scene in the video: The start and/or end scene is indicated, in various implementations, using a time indicator, a picture number indicator, or a scene number indicator.
   a. Sₛₜₐᵣₜ indicates the starting scene in the video.
   b. S_{end} indicates the ending scene in the video.
2. Appearance frequency of main characters:
   a. Cᵣₐₙₖ[j], j=1, 2, 3, . . . , N, Cᵣₐₙₖ[j] is the appearance frequency of the j^{th} character in the video, where N is the total number of characters in the video.
   b. Cᵣₐₙₖ[j]=AN[j]/TOTAL, where AN[j] is the Appearance Number of the j^{th} character and TOTAL=Σⱼ₌₁ⁿAN[j]. The appearance number (character appearances) is the number of times that the character is in the video. The value of Cᵣₐₙₖ [j] is, therefore, a number between zero and one, and provides a ranking of all characters based on the number of times they appear in the video.
      Character appearances can be determined in various ways, such as, for example, by searching the script. For example, in the scene of FIG. 2, the name “Tom” appears two times in the Scene Description 220, and two times as a Speaking Character 230. By counting the occurrences of the name “Tom”, we can accumulate, for example, (i) one occurrence, to reflect the fact that Tom appears in the scene, as determined by any appearance of the word “Tom” in the script, (ii) two occurrences, to reflect the number of monologues without an intervening monologue by another character, as determined, for example, by the number of times “Tom” appears as in the Speaking Character 230 text, (iii) two occurrences, to reflect the number of times “Tom” appears in the Scene Description 220 text, or (iv) four occurrences, to reflect the number of times that “Tom” appears as part of either the Scene Description 220 text or the Speaking Character 230 text.
   c. Cᵣₐₙₖ [j] are sorted in descending order. Thus, Cᵣₐₙₖ [1] is the appearance frequency for the most frequently occurring character.
3. Length of the scene:
   a. LEN[i], i=1, 2, . . . , M, is the length of the i^{th} scene, typically measured in the number of pictures, where M is the total number of scenes defined in the script.
   b. LEN[i] can be calculated in the Synchronization Unit 410, described later with respect to FIG. 4. Each scene described in the script will be mapped to a period of pictures in the video. The length of a scene can be defined as, for example, the number of pictures corresponding to the scene. Other implementations define the length of a scene as, for example, the length of time corresponding to the scene.
   c. The length of each scene is, in various implementations, normalized by the following formula:

S_{LEN}[i]=LEN[i]/Video_Len, i=1,2, . . . M,
where Video_Len=Σᵢ₌₁^{M}LEN[i].
4. Level of highlighted actions or objects in the scene:
   a. L_{high}[i], i=1, 2, . . . , M, is defined as the level of highlighted actions or objects in the i^{th} scene, where M is the total number of scenes defined in the script.
   b. Scenes with highlighted actions or objects can be detected by, for example, highlight-word detection in the script. For example, by detecting various highlight action words (or groups of words) such as, for example: look, turn to, run, climb, kiss, etc., or by detecting various highlight object words such as, for example: door, table, water, car, gun, office, etc.
   c. In at least one embodiment, L_{high}[i] can be defined simply by the number of highlight words that appear in, for example, the scene description of the i^{th} scene, which are scaled by the following formula:

L_{high}[i]=L_{high}[i]/maximum(L_{high}[i], i=1,2, . . . ,M).

In at least one implementation, except for the start scene and the end scene, all other scene weights (shown as the weight for a scene “i”) are calculated by the following formula:

$${SCE}_{Weight} [ i ] = {( {\sum }_{j = 1}^{N} W [ j ] * {C}_{rank} [ j ] * SHOW [ j ] [ i ] + 1 )}^{1 + α} * {S}_{LEN} [ i ] * {( 1 + {L}_{high} [ i ] )}^{1 + β} , \\ i = 2 , 3 , … , M - 1$$

where:
SHOW[j][i] is the appearance number, for scene “i”, of the j^{th} main character of the video. This is the portion of AN[j] that occurs in scene “i”. SHOW[j][i] can be calculated by scanning the scene and performing the same type of counts as is done to determine AN[j].
W[j], j=1, 2, . . . , N, α, and β are weight parameters. These parameters can be defined via data training from a benchmark dataset, such that desired results are achieved. Alternatively, the weight parameters can be set by a user. In one particular embodiment:
   W[1]=5, W[2]=3, and W[j]=0, j=3, . . . , N, and
   α=0.5, and
   β=0.1.

In various such implementations, Sₛₜₐᵣₜ and S_{end} are given the highest weights, in order to increase the representation of the start scene and the end scene in the pictorial summary. This is done because the start scene and the end scene are typically important in the narration of the video. The weights of the start scene and the end scene are calculated as follows for one such implementation:

$$\begin{matrix}{SCE}_{Weight} [ 1 ] = {SCE}_{Weight} [ M ] \\ = maximum ( {SCE}_{Weight} [ i ] , i = 2 , 3 , … , M - 1 ) + 1\end{matrix}$$

The process 300 includes budgeting the pictorial summary pictures among the scenes in the video (340). Various implementations allow the user to configure, in the user input operation 310, the maximum length (that is, the maximum number of pages, referred to as PAGES) of the pictorial summary that is generated from the video (for example, movie content). The variable, PAGES, is converted into a maximum number of pictorial summary highlight pictures, T_{highlight}, using the formula:

T_{highlight}=PAGES*NUMFₚ,

where NUMFₚ is the average number of pictures (frequently referred to as frames) allocated to each page of a pictorial summary, which is set at 5 in at least one embodiment and can also be set by user interactive operation (for example, in the user input operation 310).

Using that input, at least one implementation determines the picture budget (for highlight picture selection for the pictorial summary) that is to be allocated to the i^{th} scene from the following formula:

FBug[i]=ceil(T_{highlight}*SCE_{weight}[i]/Σᵢ₌₁^{M}SCE_{weight}[i])

This formula allocates a fraction of the available pictures, based on the scene's fraction of total weight, and then rounds up using the ceiling function. It is to be expected that towards the end of the budgeting operation, it may not be possible to round up all scene budgets without exceeding T_{highlight}. In such a case, various implementations, for example, exceed T_{highlight}, and other implementations, for example, begin rounding down.

Recall that various implementations weight a portion of the video other than a scene. In many such implementations, the operation 340 is frequently replaced with an operation that budgets the pictorial summary pictures among the weighted portions (not necessarily scenes) of the video.

The process 300 includes evaluating the pictures in the scenes, or more generally, in the video (350). In various implementations, for each scene “i”, the Appealing Quality is calculated for every picture in the scene as follows:
1. AQ[k], k=1, 2, . . . , Tᵢ, indicates the Appealing Quality of each image in the i^{th} scene, where Tᵢ is the total number of pictures in the i^{th} scene.
2. Appealing Quality can be calculated based on image quality factors, such as, for example, PSNR (Peak Signal Noise Ratio), Sharpness level, Color Harmonization level (for example, subjective analyses to assess whether the colors of a picture harmonize well with each other), and/or Aesthetic level (for example, subjective evaluations of the color, layout, etc.).
3. In at least one embodiment, AQ[k] is defined as the sharpness level of the picture, which is calculated, for example, using the following function:

AQ[k]=PIX_{edges}/PIXₜₒₜₐₗ.
Where:
   PIX_{edges} is the number of edge pixels in the picture, and
   PIXₜₒₜₐₗ is the total number of pixels in the picture.

The process 300 includes selecting pictures for the pictorial summary (360). This operation 360 is often referred to as selecting highlight pictures. In various implementations, for each scene “i”, the following operations are performed:
AQ[k], k=1, 2, . . . Tᵢ are sorted in descending order, and the top FBug[i] pictures are selected as the highlight pictures, for scene “i”, to be included in the final pictorial summary.
If (i) AQ[m]=AQ[n], or more generally, if AQ[m] is within a threshold of AQ[n], and (ii) picture m and picture n are in the same shot, then only one of picture m and picture n will be selected for the final pictorial summary. This helps to ensure that pictures, from the same shot, that are of similar quality are not both included in the final pictorial summary. Instead, another picture is selected. Often, the additional picture that is included (that is, the last picture that is included) for that scene will be from a different shot. For example, if (i) a scene is budgeted three pictures, pictures “1”, “2”, and “3”, and (ii) AQ[1] is within a threshold of AQ[2], and therefore (iii) picture “2” is not included but picture “4” is included, then (iv) it will often be the case that picture 4 is from a different shot than picture 2.

Other implementations perform any of a variety of methodologies to determine which pictures from a scene (or other portion of a video to which a budget has been applied) to include in the pictorial summary. One implementation takes the picture from each shot that has the highest Appealing Quality (that is, AQ[1]), and if there are remaining pictures in FBug[i], then the remaining pictures with the highest Appealing Quality, regardless of shot, are selected.

The process 300 includes providing the pictorial summary (370). In various implementations, providing (370) includes displaying the pictorial summary on a screen. Other implementations provide the pictorial summary for storage and/or transmission.

Referring to FIG. 4, a block diagram of a system 400 is provided. The system 400 is an example of a system for generating a pictorial summary. The system 400 can be used, for example, to perform the process 300.

The system 400 accepts as input a video 404, a script 406, and user input 408. The provision of these inputs can correspond, for example, to the user input operation 310.

The video 404 and the script 406 correspond to each other. For example, in typical implementations, the video 404 and the script 406 are both for a single movie. The user input 408 includes input for one or more of a variety of units, as explained below.

The system 400 includes a synchronization unit 410 that synchronizes the script 406 and the video 404. At least one implementation of the synchronization unit performs the synchronizing operation 320.

The synchronization unit 410 provides a synchronized video as output. The synchronized video includes the original video 404, as well as additional information that indicates, in some manner, the synchronization with the script 406. As described earlier, various implementations use video time stamps by, for example, determining the video time stamps for pictures that correspond to the various portions of a script, and then inserting those video time stamps into the corresponding portions of the script. Other implementations determine and insert video time stamps for a scene or shot, rather than for a picture. Determining a correspondence between a portion of a script and a portion of a video can be performed, for example, (i) in various manners known in the art, (ii) in various manners described in this application, or (iii) by a human operator reading the script and watching the video.

The output from the synchronization unit 410 is, in various implementations, the original video without alteration (for example, annotation), and an annotated script, as described, for example, above. Other implementations do alter the video instead of, or in addition to, altering the script. Yet other implementations do not alter either the video or the script, but do provide synchronizing information separately. Still, further implementations do not even perform synchronization. As should be clear, depending on the type of output from the synchronization unit 410, various implementations do not need to provide the original script 406 to other units of the system 400 (such as, for example, a weighting unit 420, described below).

The system 400 includes the weighting unit 420 that receives as input (i) the script 406, (ii) the video 404 and synchronization information from the synchronization unit 410, and (iii) the user input 408. The weighting unit 420 performs, for example, the weighting operation 330 using these inputs. Various implementations allow a user, for example, to specify, using the user input 408, whether or not the first and last scenes are to have the highest weight or not.

The weighting unit 420 provides, as output, a scene weight for each scene being analyzed. Note that in some implementations, a user may desire to prepare a pictorial summary of only a portion of a movie, such as, for example, only the first ten minutes of the movie. Thus, not all scenes are necessarily analyzed in every video.

The system 400 includes a budgeting unit 430 that receives as input (i) the scene weights from the weighting unit 420, and (ii) the user input 408. The budgeting unit 430 performs, for example, the budgeting operation 340 using these inputs. Various implementations allow a user, for example, to specify, using the user input 408, whether a ceiling function (or, for example, floor function) is to be used in the budget calculation of the budgeting operation 340. Yet other implementations, allow the user to specify a variety of budgeting formulas, including non-linear equations that do not assign pictures of the pictorial summary proportionately to the scenes based on scene weight. For example, some implementations give increasingly higher percentages to scenes that are weighted higher.

The budgeting unit 430 provides, as output, a picture budget for every scene (that is, the number of pictures allocated to every scene). Other implementations provide different budgeting outputs, such as, for example, a page budget for every scene, or a budget (picture or page, for example) for each shot.

The system 400 includes an evaluation unit 440 that receives as input (i) the video 404 and synchronization information from the synchronization unit 410, and (ii) the user input 408. The evaluation unit 440 performs, for example, the evaluation operation 350 using these inputs. Various implementations allow a user, for example, to specify, using the user input 408, what type of Appealing Quality factors are to be used (for example, PSNR, Sharpness level, Color Harmonization level, Aesthetic level), and even a specific equation or a selection among available equations.

The evaluation unit 440 provides, as output, an evaluation of one or more pictures that are under consideration. Various implementations provide an evaluation of every picture under consideration. However, other implementations provide evaluations of, for example, only the first picture in each shot.

The system 400 includes a selection unit 450 that receives as input (i) the video 404 and synchronization information from the synchronization unit 410, (ii) the evaluations from the evaluation unit 440, (iii) the budget from the budgeting unit 430, and (iv) the user input 408. The selection unit 450 performs, for example, the selection operation 360 using these inputs. Various implementations allow a user, for example, to specify, using the user input 408, whether the best picture from every shot will be selected.

The selection unit 450 provides, as output, a pictorial summary. The selection unit 450 performs, for example, the providing operation 370. The pictorial summary is provided, in various implementations, to a storage device, to a transmission device, or to a presentation device. The output is provided, in various implementations, as a data file, or a transmitted bitstream.

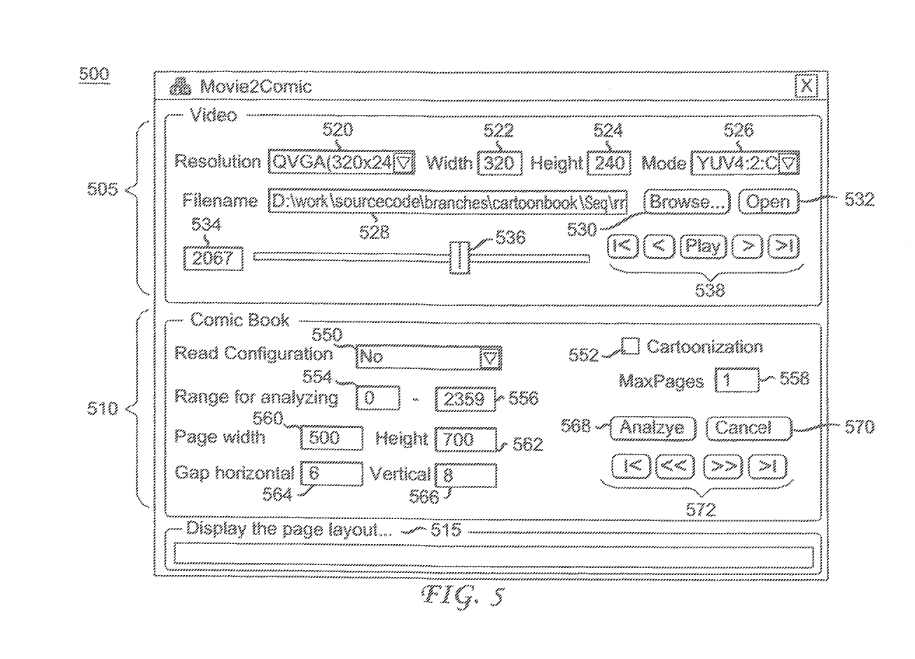

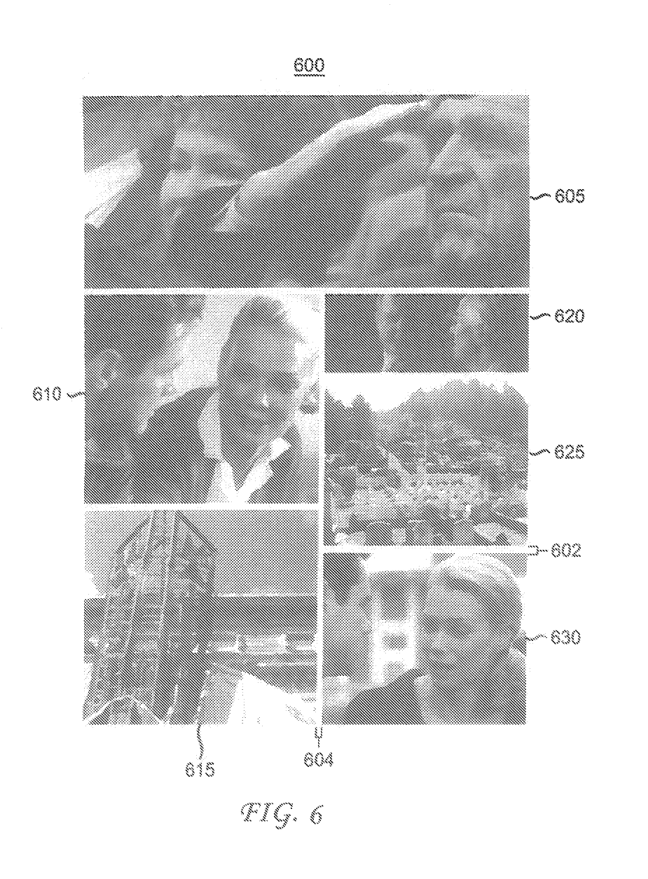

The system 400 includes a presentation unit 460 that receives as input the pictorial summary from, for example, the selection unit 450, a storage device (not shown), or a receiver (not shown) that receives, for example, a broadcast stream including the pictorial summary. The presentation unit 460 includes, for example, a television, a computer, a laptop, a tablet, a cell phone, or some other communications device or processing device. The presentation unit 460 in various implementations provides a user interface and/or a screen display as shown in FIGS. 5 and 6 below, respectively.

The elements of the system 400 can by implemented by, for example, hardware, software, firmware, or combinations thereof. For example, one or more processing devices, with appropriate programming for the functions to be performed, can be used to implement the system 400.

Referring to FIG. 5, a user interface screen 500 is provided. The user interface screen 500 is output from a tool for generating a pictorial summary. The tool is labeled “Movie2Comic” in FIG. 5. The user interface screen 500 can be used as part of an implementation of the process 300, and can be generated using an implementation of the system 400.

The screen 500 includes a video section 505 and a comic book (pictorial summary) section 510. The screen 500 also includes a progress field 515 that provides indications of the progress of the software. The progress field 515 of the screen 500 is displaying an update that says “Display the page layout . . . ” to indicate that the software is now displaying the page layout. The progress field 515 will change the displayed update according to the progress of the software.

The video section 505 allows a user to specify various items of video information, and to interact with the video, including:
specifying video resolution, using a resolution field 520,
specifying width and height of the pictures in the video, using a width field 522 and a height field 524,
specifying video mode, using a mode field 526,
specifying a source file name for the video, using a filename field 528,
browsing available video files using a browse button 530, and opening a video file using an open button 532,
specifying a picture number to display (in a separate window), using a picture number field 534,
selecting a video picture to display (in the separate window), using a slider bar 536, and
navigating within a video (displayed in the separate window), using a navigation button grouping 538.

The comic book section 510 allows a user to specify various pieces of information for the pictorial summary, and to interact with the pictorial summary, including:
indicating whether a new pictorial summary is to be generated (“No”), or whether the previously generated pictorial summary is to be re-used (“Yes”), using a read configuration field 550 (For example, if the pictorial summary has already been generated, the software can read the configuration to show the previously generated pictorial summary without duplicating the previous computation.),
specifying whether the pictorial summary is to be generated with an animated look, using a cartoonization field 552,
specifying a range of a video for use in generating the pictorial summary, using a beginning range field 554 and an ending range field 556,
specifying a maximum number of pages for the pictorial summary, using a MaxPages field 558,
specifying the size of the pictorial summary pages, using a page width field 560 and a page height field 562, both of which are specified in numbers of pixels (other implementations use other units),
specifying the spacing between pictures on a pictorial summary page, using a horizontal gap field 564 and a vertical gap field 566, both of which are specified in numbers of pixels (other implementations use other units),
initiating the process of generating a pictorial summary, using an analyze button 568,
abandoning the process of generating a pictorial summary, and closing the tool, using a cancel button 570, and
navigating a pictorial summary (displayed in a separate window), using a navigation button grouping 572.

It should be clear that the screen 500 provides an implementation of a configuration guide. The screen 500 allows a user to specify the various discussed parameters. Other implementations provide additional parameters, with or without providing all of the parameters indicated in the screen 500. Various implementations also specify certain parameters automatically and/or provide default values in the screen 500. As discussed above, the comic book section 510 of the screen 500 allows a user to specify, at least, one or more of (i) a range from a video that is to be used in generating a pictorial summary, (ii) a width for a picture in the generated pictorial summary, (iii) a height for a picture in the generated pictorial summary, (iv) a horizontal gap for separating pictures in the generated pictorial summary, (v) a vertical gap for separating pictures in the generated pictorial summary, or (vi) a value indicating a desired number of pages for the generated pictorial summary.

Referring to FIG. 6, a screen shot 600 is provided from the output of the “Movie2Comic” tool mentioned in the discussion of FIG. 5. The screen shot 600 is a one-page pictorial summary generated according to the specifications shown in the user interface screen 500. For example:
the screen shot 600 has a page width of 500 pixels (see the page width field 560),
the screen shot 600 has a page height of 700 pixels (see the page height field 562),
the pictorial summary has only one page (see the MaxPages field 558),
the screen shot 600 has a vertical gap 602 between pictures of 8 pixels (see the vertical gap field 566), and
the screen shot 600 has a horizontal gap 604 between pictures of 6 pixels (see the horizontal gap field 564).

The screen shot 600 includes six pictures, which are highlight pictures from a video identified in the user interface screen 500 (see the filename field 528). The six pictures, in order of appearance in the video, are:
a first picture 605, which is the largest of the six pictures, and is positioned along the top of the screen shot 600, and which shows a front perspective view of a man saluting,
a second picture 610, which is about half the size of the first picture 605, and is positioned mid-way along the left-hand side of the screen shot 600 under the left-hand portion of the first picture 605, and which shows a woman's face as she talks with a man next to her,
a third picture 615, which is the same size as the second picture 610, and is positioned under the second picture 610, and which shows a portion of the front of a building and an iconic sign,
a fourth picture 620, which is the smallest picture and is less than half the size of the second picture 610, and is positioned under the right-hand side of the first picture 605, and which provides a front perspective view of a shadowed image of two men talking to each other,
a fifth picture 625, which is a little smaller than the second picture 610 and approximately twice the size of the fourth picture 620, and is positioned under the fourth picture 620, and which shows a view of a cemetery, and
a sixth picture 630, which is the same size as the fifth picture 625, and is positioned under the fifth picture 625, and which shows another image of the woman and man from the second picture 610 talking to each other in a different conversation, again with the woman's face being the focus of the picture.

Each of the six pictures 605-630 is automatically sized and cropped to focus the picture on the objects of interest. The tool also allows a user to navigate the video using any of the pictures 605-630. For example, when a user clicks on, or (in certain implementations) places a cursor over, one of the pictures 605-630, the video begins playing from that point of the video. In various implementations, the user can rewind, fast forward, and use other navigation operations.

Various implementations place the pictures of the pictorial summary in an order that follows, or is based on, (i) the temporal order of the pictures in the video, (ii) the scene ranking of the scenes represented by the pictures, (iii) the appealing quality(AQ) rating of the pictures of the pictorial summary, and/or (iv) the size, in pixels, of the pictures of the pictorial summary. Furthermore, the layout of the pictures of a pictorial summary (for example, the pictures 605-630) is optimized in several implementations. More generally, a pictorial summary is produced, in certain implementations, according to one or more of the implementations described in EP patent application number 2 207 111, which is hereby incorporated by reference in its entirety for all purposes.

As should be clear, in typical implementations, the script is annotated with, for example, video time stamps, but the video is not altered. Accordingly, the pictures 605-630 are taken from the original video, and upon clicking one of the pictures 605-630 the original video begins playing from that picture. Other implementations alter the video in addition to, or instead of, altering the script. Yet other implementations, do not alter either the script or the video, but, rather, provide separate synchronizing information.

The six pictures 605-630 are actual pictures from a video. That is, the pictures have not been animated using, for example, a cartoonization feature. Other implementations, however, do animate the pictures before including the pictures in the pictorial summary.

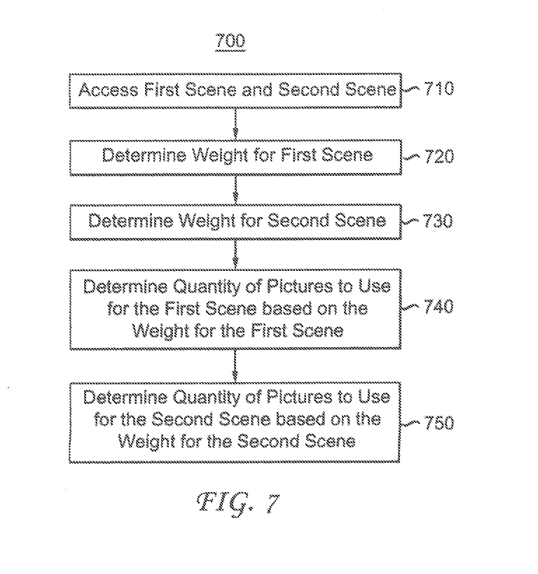

Referring to FIG. 7, a flow diagram of a process 700 is provided. Generally speaking, the process 700 allocates, or budgets, pictures in a pictorial summary to different scenes. Variations of the process 700 allow budgeting pictures to different portions of a video, wherein the portions are not necessarily scenes.

The process 700 includes accessing a first scene and a second scene (710). In at least one implementation, the operation 710 is performed by accessing a first scene in a video, and a second scene in the video.

The process 700 includes determining a weight for the first scene (720), and determining a weight for the second scene (730). The weights are determined, in at least one implementation, using the operation 330 of FIG. 3.

The process 700 includes determining a quantity of pictures to use for the first scene based on the weight for the first scene (740). In at least one implementation, the operation 740 is performed by determining a first number that identifies how many pictures from the first portion are to be used in a pictorial summary of a video. In several such implementations, the first number is one or more, and is determined based on the weight for the first portion. The quantity of pictures is determined, in at least one implementation, using the operation 340 of FIG. 3.

The process 700 includes determining a quantity of pictures to use for the second scene based on the weight for the second scene (750). In at least one implementation, the operation 750 is performed by determining a second number that identifies how many pictures from the second portion are to be used in a pictorial summary of a video. In several such implementations, the second number is one or more, and is determined based on the weight for the second portion. The quantity of pictures is determined, in at least one implementation, using the operation 340 of FIG. 3.

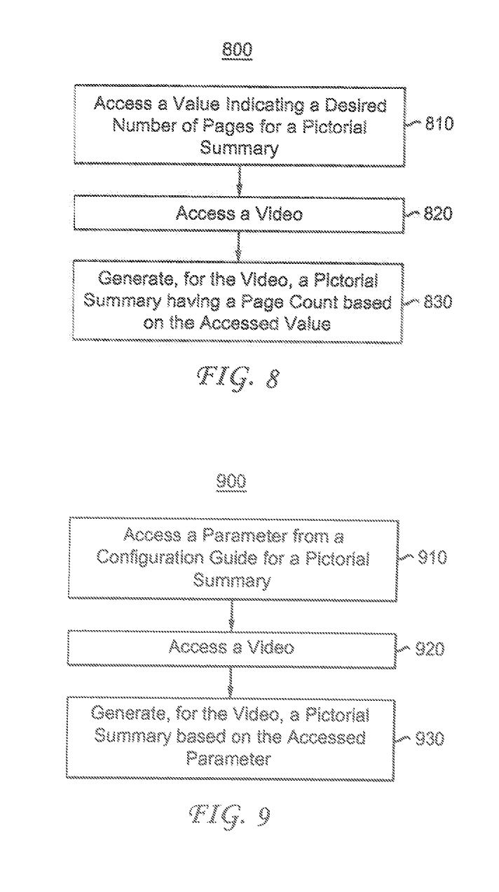

Referring to FIG. 8, a flow diagram of a process 800 is provided. Generally speaking, the process 800 generates a pictorial summary for a video. The process 800 includes accessing a value indicating a desired number of pages for a pictorial summary (810). The value is accessed, in at least one implementation, using the operation 310 of FIG. 3.

The process 800 includes accessing a video (820). The process 800 further includes generating, for the video, a pictorial summary having a page count based on the accessed value (830). In at least one implementation, the operation 830 is performed by generating a pictorial summary for a video, wherein the pictorial summary has a total number of pages, and the total number of pages is based on an accessed value indicating a desired number of pages for the pictorial summary.

Referring to FIG. 9, a flow diagram of a process 900 is provided. Generally speaking, the process 900 generates a pictorial summary for a video. The process 900 includes accessing a parameter from a configuration guide for a pictorial summary (910). In at least one implementation, the operation 910 is performed by accessing one or more parameters from a configuration guide that includes one or more parameters for configuring a pictorial summary of a video. The one or more parameters are accessed, in at least one implementation, using the operation 310 of FIG. 3.

The process 900 includes accessing the video (920). The process 900 further includes generating, for the video, a pictorial summary based on the accessed parameter (930). In at least one implementation, the operation 930 is performed by generating the pictorial summary for the video, wherein the pictorial summary conforms to one or more accessed parameters from the configuration guide.

Various implementations of the process 900, or of other processes, include accessing one or more parameters that relate to the video itself. Such parameters include, for example, the video resolution, the video width, the video height, and/or the video mode, as well as other parameters, as described earlier with respect to the video section 505 of the screen 500. In various implementations, the accessed parameters (relating to the pictorial summary, the video, or some other aspect) are provided, for example, (i) automatically by a system, (ii) by user input, and/or (iii) by default values in a user input screen (such as, for example, the screen 500).

The process 700 is performed, in various implementations, using the system 400 to perform selected operations of the process 300. Similarly, the processes 800 and 900 are performed, in various implementations, using the system 400 to perform selected operations of the process 300.

In various implementations, there are not enough pictures in a pictorial summary to represent all of the scenes. For other implementations, there could be enough pictures in theory, but given that higher-weighted scenes are given more pictures, these implementations run out of available pictures before representing all of the scenes in the pictorial summary. Accordingly, variations of many of these implementations include a feature that allocates pictures (in the pictorial summary) to the higher-weighted scenes first. In that way, if the implementation runs out of available pictures (in the pictorial summary), then the higher-weighted scenes have been represented. Many such implementations process scenes in order of decreasing scene weight, and therefore do not allocate pictures (in the pictorial summary) to a scene until all higher-weighted scenes have had pictures (in the pictorial summary) allocated to them.

In various implementations that do not have “enough” pictures to represent all scenes in the pictorial summary, the generated pictorial summary uses pictures from one or more scenes of the video, and the one or more scenes are determined based on a ranking that differentiates between scenes of the video including the one or more scenes. Certain implementations apply this feature to portions of a video other than scenes, such that the generated pictorial summary uses pictures from one or more portions of the video, and the one or more portions are determined based on a ranking that differentiates between portions of the video including the one or more portions. Several implementations determine whether to represent a first portion (of a video, for example) in a pictorial summary by comparing a weight for the first portion with respective weights of other portions of the video. In certain implementations, the portions are, for example, shots.

It should be clear that some implementations use a ranking (of scenes, for example) both (i) to determine whether to represent a scene in a pictorial summary, and (ii) to determine how many picture(s) from a represented scene to include in the pictorial summary. For example, several implementations process scenes in order of decreasing weight (a ranking that differentiates between the scenes) until all positions in the pictorial summary are filled. Such implementations thereby determine which scenes are represented in the pictorial summary based on the weight, because the scenes are processed in order of decreasing weight. Such implementations also determine how many pictures from each represented scene are included in the pictorial summary, by, for example, using the weight of a scene to determine the number of budgeted pictures for the scene.

Variations of some of the above implementations determine initially whether, given the number of pictures in the pictorial summary, all scenes will be able to be represented in the pictorial summary. If the answer is “no”, due to a lack of available pictures (in the pictorial summary), then several such implementations change the allocation scheme so as to be able to represent more scenes in the pictorial summary (for example, allocating only one picture to each scene). This process produces a result similar to changing the scene weights. Again, if the answer is “no”, due to a lack of available pictures (in the pictorial summary), then some other implementations use a threshold on the scene weight to eliminate low-weighted scenes from being considered at all for the pictorial summary.

Note that various implementations simply copy selected pictures into the pictorial summary. However, other implementations perform one or more of various processing techniques on the selected pictures before inserting the selected pictures into the pictorial summary. Such processing techniques include, for example, cropping, re-sizing, scaling, animating (for example, applying a “cartoonization” effect), filtering (for example, low-pass filtering, or noise filtering), color enhancement or modification, and light-level enhancement or modification. The selected pictures are still considered to be “used” in the pictorial summary, even if the selected pictures are processed prior to being inserted into the pictorial summary.

Various implementations are described that allow a user to specify the desired number of pages, or pictures, for the pictorial summary. Several implementations, however, determine the number of pages, or pictures, without user input. Other implementations allow a user to specify the number of pages, or pictures, but if the user does not provide a value then these implementations make the determination without user input. In various implementations that determine the number of pages, or pictures, without user input, the number is set based on, for example, the length of the video (for example, a movie) or the number of scenes in a video. For a video that has a run-length of two hours, a typical number of pages (in various implementations) for a pictorial summary is approximately thirty pages. If there are six pictures per page, then a typical number of pictures in such implementations is approximately one-hundred eighty.

A number of implementations have been described. Variations of these implementations are contemplated by this disclosure. A number of variations are obtained by the fact that many of the elements in the figures, and in the implementations are optional in various implementations. For example:
The user input operation 310, and the user input 408, are optional in certain implementations. For example, in certain implementations the user input operation 310, and the user input 408, are not included. Several such implementations fix all of the parameters, and do not allow a user to configure the parameters. By stating (here, and elsewhere in this application) that particular features are optional in certain implementations, it is understood that some implementations will require the features, other implementations will not include the features, and yet other implementations will provide the features as an available option and allow (for example) a user to determine whether to use that feature.
The synchronization operation 320, and the synchronization unit 410, are optional in certain implementations. Several implementations need not perform synchronization because the script and the video are already synchronized when the script and the video are received by the tool that generates the pictorial summary. Other implementations do not perform synchronization of the script and the video because those implementations perform scene analysis without a script. Various such implementations, that do not use a script, instead use and analyze one or more of (i) close caption text, (ii) sub-title text, (iii) audio that has been turned into text using voice recognition software, (iv) object recognition performed on the video pictures to identify, for example, highlight objects and characters, or (v) metadata that provides information previously generated that is useful in synchronization.
The evaluation operation 350, and the evaluation unit 440, are optional in certain implementations. Several implementations do not evaluate the pictures in the video. Such implementations perform the selection operation 360 based on one or more criteria other than the Appealing Quality of the pictures.
The presentation unit 460 is optional in certain implementations. As described earlier, various implementations provide the pictorial summary for storage or transmission without presenting the pictorial summary.

A number of variations are obtained by modifying, without eliminating, one or more elements in the figures, and in the implementations. For example:
The weighting operation 330, and the weighting unit 420, can weight scenes in a number of different ways, such as, for example:
   1. Weighting of scenes can be based on, for example, the number of pictures in the scene. One such implementation assigns a weight proportional to the number of pictures in the scene. Thus, the weight is, for example, equal to the number of pictures in the scene (LEN[i]), divided by the total number of pictures in the video.
   2. Weighting of scenes can be proportional to the level of highlighted actions or objects in the scene. Thus, in one such implementation, the weight is equal to the level of highlighted actions or objects for scene “i” (L_{high}[i]) divided by the total level of highlighted actions or objects in the video (the sum of L_{high}[i] for all “i”).
   3. Weighting of scenes can be proportional to the Appearance Number of one or more characters in the scene. Thus, in various such implementations, the weight for scene “i” is equal to the sum of SHOW[j][i], for j=1 . . . F, where F is chosen or set to be, for example, three (indicating that only the top three main characters of the video are considered) or some other number. The value of F is set differently in different implementations, and for different video content. For example, in James Bond movies, F can be set to a relatively small number so that the pictorial summary is focused on James Bond and the primary villain.
   4. Variations of the above examples provide a scaling of the scene weights. For example, in various such implementations, the weight for scene “i” is equal to the sum of (gamma[i] *SHOW[j][i]), for j=1 . . . F. “gamma[i]” is a scaling value (that is, a weight), and can be used, for example, to give more emphasis to appearances of the primary character (for example, James Bond).
   5. A “weight” can be represented by different types of values in different implementations. For example, in various implementations, a “weight” is a ranking, an inverse (reverse-order) ranking, or a calculated metric or score (for example, LEN[i]). Further, in various implementations the weight is not normalized, but in other implementations the weight is normalized so that the resulting weight is between zero and one.
   6. Weighting of scenes can be performed using a combination of one or more of the weighting strategies discussed for other implementations. A combination can be, for example, a sum, a product, a ratio, a difference, a ceiling, a floor, an average, a median, a mode, etc.
   7. Other implementations weight scenes without regard to the scene's position in the video, and therefore do not assign the highest weight to the first and last scenes.
   8. Various additional implementations perform scene analysis, and weighting, in different manners. For example, some implementations search different or additional portions of the script (for example, searching all monologues, in addition to scene descriptions, for highlight words for actions or objects). Additionally, various implementations search items other than the script in performing scene analysis, and weighting, and such items include, for example, (i) close caption text, (ii) sub-title text, (iii) audio that has been turned into text using voice recognition software, (iv) object recognition performed on the video pictures to identify, for example, highlight objects (or actions) and character appearances, or (v) metadata that provides information previously generated for use in performing scene analysis.
   9. Various implementations apply the concept of weighting to a set of pictures that is different from a scene. In various implementations (involving, for example, short videos), shots (rather than scenes) are weighted and the highlight-picture budget is allocated among the shots based on the shot weights. In other implementations, the unit that is weighted is larger than a scene (for example, scenes are grouped, or shots are grouped) or smaller than a shot (for example, individual pictures are weighted based on, for example, the “appealing quality” of the pictures). Scenes, or shots, are grouped, in various implementations, based on a variety of attributes. Some examples include (i) grouping together scenes or shots based on length (for example, grouping adjacent short scenes), (ii) grouping together scenes or shots that have the same types of highlighted actions or objects, or (iii) grouping together scenes or shots that have the same main character(s).
The budgeting operation 340, and the budgeting unit 430, can allocate or assign pictorial summary pictures to a scene (or some other portion of a video) in various manners. Several such implementations assign pictures based on, for example, a non-linear assignment that gives higher weighted scenes a disproportionately higher (or lower) share of pictures. Several other implementations simply assign one picture per shot.
The evaluating operation 350, and the evaluation unit 440, can evaluate pictures based on, for example, characters present in the picture and/or the picture's position in the scene (for example, the first picture in the scene and the last picture in the scene can receive a higher evaluation). Other implementations evaluate entire shots or scenes, producing a single evaluation (typically, a number) for the entire shot or scene rather than for each individual picture.
The selection operation 360, and the selection unit 450, can select pictures as highlight pictures to be included in the pictorial summary using other criteria. Several such implementations select the first, or last, picture in every shot as a highlight picture, regardless of the quality of the picture.
The presentation unit 460 can be embodied in a variety of different presentation devices. Such presentation devices include, for example, a television (“TV”) (with or without picture-in-picture (“PIP”) functionality), a computer display, a laptop display, a personal digital assistant (“PDA”) display, a cell phone display, and a tablet (for example, an iPad) display. The presentation devices are, in different implementations, either a primary or a secondary screen. Still other implementations use presentation devices that provide a different, or additional, sensory presentation. Display devices typically provide a visual presentation. However, other presentation devices provide, for example, (i) an auditory presentation using, for example, a speaker, or (ii) a haptic presentation using, for example, a vibration device that provides, for example, a particular vibratory pattern, or a device providing other haptic (touch-based) sensory indications.
Many of the elements of the described implementations can be reordered or rearranged to produce yet further implementations. For example, many of the operations of the process 300 can be rearranged, as suggested by the discussion of the system 400. Various implementations move the user input operation to one or more other locations in the process 300, such as, for example, right before one or more of the weighting operation 330, the budgeting operation 340, the evaluating operation 350, or the selecting operation 360. Various implementations move the evaluating operation 350 to one or more other locations in the process 300, such as, for example, right before one or more of the weighting operation 330 or the budgeting operation 340.

Several variations of described implementations involve adding further features. One example of such a feature is a “no spoilers” feature, so that crucial story points are not unintentionally revealed. Crucial story points of a video can include, for example, who the murderer is, or how a rescue or escape is accomplished. The “no spoilers” feature of various implementations operates by, for example, not including highlights from any scene, or alternatively from any shot, that are part of, for example, a climax, a denouement, a finale, or an epilogue. These scenes, or shots, can be determined, for example, by (i) assuming that all scenes or shots within the last ten (for example) minutes of a video should be excluded, or by (ii) metadata that identifies the scenes and/or shots to be excluded, wherein the metadata is provided by, for example, a reviewer, a content producer, or a content provider.

Various implementations assign weight to one or more different levels of a hierarchical fine-grain structure. The structure includes, for example, scenes, shots, and pictures. Various implementations weight scenes in one or more manners, as described throughout this application. Various implementations also, or alternatively, weight shots and/or pictures, using one or more manners that are also described throughout this application. Weighting of shots and/or pictures can be performed, for example, in one or more of the following manners:
(i) The Appealing Quality (AQ) of a picture can provide an implicit weight for pictures (see, for example, the operation 350 of the process 300). The weight for a given picture is, in certain implementations, the actual value of the AQ for the given picture. In other implementations, the weight is based on (not equal to) the actual value of the AQ, such as, for example, a scaled or normalized version of the AQ.
(ii) In other implementations, the weight for a given picture is equal to, or based on, the ranking of the AQ values in an ordered listing of the AQ values (see, for example, the operation 360 of the process 300, which ranks AQ values).
(iii) The AQ also provides a weighting for shots. The actual weight for any given shot is, in various implementations, equal to (or based on) the AQ values of the shot's constituent pictures. For example, a shot has a weight equal to the average AQ of the pictures in the shot, or equal to the highest AQ for any of the pictures in the shot.
(iv) In other implementations, the weight for a given shot is equal to, or based on, the ranking of the shot's constituent pictures in an ordered listing of the AQ values (see, for example, the operation 360 of the process 300, which ranks AQ values). For example, pictures with higher AQ values appear higher in the ordered listing (which is a ranking), and the shots that include those “higher ranked” pictures have a higher probability of being represented (or being represented with more pictures) in the final pictorial summary. This is true even if additional rules limit the number of pictures from any given shot that can be included in the final pictorial summary. The actual weight for any given shot is, in various implementations, equal to (or based on) the position(s) of the shot's constituent pictures in the ordered AQ listing. For example, a shot has a weight equal to (or based on) the average position (in the ordered AQ listing) of the shot's pictures, or equal to (or based on) the highest position for any of the shot's pictures.

A number of independent systems or products are provided in this application. For example, this application describes systems for generating a pictorial summary starting with the original video and script. However, this application also describes a number of other systems, including, for example:
Each of the units of the system 400 can stand alone as a separate and independent entity and invention. Thus, for example, a synchronization system can correspond, for example, to the synchronization unit 410, a weighting system can correspond to the weighting unit 420, a budgeting system can correspond to the budgeting unit 430, an evaluation system can correspond to the evaluation unit 440, a selection system can correspond to the selection unit 450, and a presentation system can correspond to the presentation unit 460.
Further, at least one weight and budgeting system includes the functions of weighting scenes (or other portions of the video) and allocating a picture budget among the scenes (or other portions of the video) based on the weights. One implementation of a weight and budgeting system consists of the weighting unit 420 and the budgeting unit 430.
Further, at least one evaluation and selection system includes the functions of evaluating pictures in a video and selecting certain pictures, based on the evaluations, to include in a pictorial summary. One implementation of an evaluation and selection system consists of the evaluation unit 440 and the selection unit 450.
Further, at least one budgeting and selection system includes the functions of allocating a picture budget among scenes in a video, and then selecting certain pictures (based on the budget) to include in a pictorial summary. One implementation of a budgeting and selection system consists of the budgeting unit 430 and the selection unit 450. An evaluation function, similar to that performed by the evaluation unit 440, is also included in various implementations of the budgeting and selection system.

Implementations described in this application provide one or more of a variety of advantages. Such advantages include, for example:
providing a process for generating a pictorial summary, wherein the process is (i) adaptive to user input, (ii) fine-grained by evaluating each picture in a video, and/or (iii) hierarchical by analyzing scenes, shots, and individual pictures,
assigning weight to different levels of a hierarchical fine-grain structure that includes scenes, shots, and highlight pictures,
identifying different levels of importance (weights) to a scene (or other portion of a video) by considering one or more features such as, for example, the scene position within a video, the appearance frequency of main characters, the length of the scene, and the level/amount of highlighted actions or objects in the scene,
considering the“appealing quality” factor of a picture in selecting highlight pictures for the pictorial summary,
keeping the narration property in defining the weight of a scene, a shot, and a highlight picture, wherein keeping the “narration property” refers to preserving the story of the video in the pictorial summary such that a typical viewer of the pictorial summary can still understand the video's story by viewing only the pictorial summary,
considering factors related to how “interesting” a scene, a shot, or a picture is, when determining a weight or ranking, such as, for example, by considering the presence of highlight actions/words and the presence of main characters, and/or
using one or more of the following factors in a hierarchical process that analyzes scenes, shots, and individual pictures in generating a pictorial summary: (i) favoring the start scene and the end scene, (ii) the appearance frequency of the main characters, (iii) the length of the scene, (iv) the level of highlighted actions or objects in the scene, or (v) an“appealing quality” factor for a picture.

This application provides implementations that can be used in a variety of different environments, and that can be used for a variety of different purposes. Some examples include, without limitation:
Implementations are used for automatic scene-selection menus for DVD or over-the-top (“OTT”) video access.
Implementations are used for pseudo-trailer generation. For example, a pictorial summary is provided as an advertisement. Each of the pictures in the pictorial summary offers a user, by clicking on the picture, a clip of the video beginning at that picture. The length of the clip can be determined in various manners.
Implementations are packaged as, for example, an app, and allow fans (of various movies or TV series, for example) to create summaries of episodes, of seasons, of an entire series, etc. A fan selects the relevant video(s), or selects an indicator for a season, or for a series, for example. These implementations are useful, for example, when a user wants to “watch” an entire season of a show over a few days without having to watch every minute of every show. These implementations are also useful for reviewing prior season(s), or to remind oneself of what was previously watched. These implementations can also be used as an entertainment diary, allowing a user to keep track of the content that the user has watched.
Implementations that operate without a fully structured script (for example, with only closed captions), can operate on a television, by examining and processing the TV signal. A TV signal does not have a script, but such implementations do not need to have additional information (for example, a script). Several such implementations can be set to automatically create pictorial summaries of all shows that are viewed. These implementations are useful, for example, (i) in creating a entertainment diary, or (ii) for parents in tracking what their children have been watching on TV.
Implementations, whether operating in the TV as described above, or not, are used to improve electronic program guide (“EPG”) program descriptions. For example, some EPGs display only a three-line text description of a movie or series episode. Various implementations provide, instead, an automated extract of a picture (or clips) with corresponding, pertinent dialog, that gives potential viewers a gist of the show. Several such implementations are bulk-run on shows offered by a provider, prior to airing the shows, and the resulting extracts are made available through the EPG.

This application provides multiple figures, including the hierarchical structure of FIG. 1, the script of FIG. 2, the block diagram of FIG. 4, the flow diagrams of FIGS. 3 and 7-8, and the screen shots of FIGS. 5-6. Each of these figures provides disclosure for a variety of implementations.
For example, the block diagrams certainly describe an interconnection of functional blocks of an apparatus or system. However, it should also be clear that the block diagrams provide a description of a process flow. As an example, FIG. 4 also presents a flow diagram for performing the functions of the blocks of FIG. 4. For example, the block for the weighting unit 420 also represents the operation of performing scene weighting, and the block for the budgeting unit 430 also represents the operation of performing scene budgeting. Other blocks of FIG. 4 are similarly interpreted in describing this flow process.
For example, the flow diagrams certainly describe a flow process. However, it should also be clear that the flow diagrams provide an interconnection between functional blocks of a system or apparatus for performing the flow process. For example, with respect to FIG. 3, the block for the synchronizing operation 320 also represents a block for performing the function of synchronizing a video and a script. Other blocks of FIG. 3 are similarly interpreted in describing this system/apparatus. Further, FIGS. 7-8 can also be interpreted in a similar fashion to describe respective systems or apparatuses.
For example, the screen shots certainly describe a screen shown to a user. However, it should also be clear that the screen shots describe flow processes for interacting with the user. For example, FIG. 5 also describes a process of presenting a user with a template for constructing a pictorial summary, accepting input from the user, and then constructing the pictorial summary, and possibly iterating the process and refining the pictorial summary. Further, FIG. 6 can also be interpreted in a similar fashion to describe a respective flow process.

We have thus provided a number of implementations. It should be noted, however, that variations of the described implementations, as well as additional applications, are contemplated and are considered to be within our disclosure. Additionally, features and aspects of described implementations may be adapted for other implementations.

Various implementations refer to “images” and/or “pictures”. The terms “image” and “picture” are used interchangeably throughout this document, and are intended to be broad terms. An “image” or a “picture” may be, for example, all or part of a frame or of a field. The term “video” refers to a sequence of images (or pictures). An image, or a picture, may include, for example, any of various video components or their combinations. Such components, or their combinations, include, for example, luminance, chrominance, Y (of YUV or YCbCr or YPbPr), U (of YUV), V (of YUV), Cb (of YCbCr), Cr (of YCbCr), Pb (of YPbPr), Pr (of YPbPr), red (of RGB), green (of RGB), blue (of RGB), S-Video, and negatives or positives of any of these components. An “image” or a “picture” may also, or alternatively, refer to various different types of content, including, for example, typical two-dimensional video, an exposure map, a disparity map for a 2D video picture, a depth map that corresponds to a 2D video picture, or an edge map.

Reference to “one embodiment” or “an embodiment” or “one implementation” or “an implementation” of the present principles, as well as other variations thereof, mean that a particular feature, structure, characteristic, and so forth described in connection with the embodiment is included in at least one embodiment of the present principles. Thus, the appearances of the phrase “in one embodiment” or “in an embodiment” or “in one implementation” or “in an implementation”, as well any other variations, appearing in various places throughout the specification are not necessarily all referring to the same embodiment.

Additionally, this application or its claims may refer to “determining” various pieces of information. Determining the information may include one or more of, for example, estimating the information, calculating the information, predicting the information, or retrieving the information from memory.

Further, this application or its claims may refer to “accessing” various pieces of information. Accessing the information may include one or more of, for example, receiving the information, retrieving the information (for example, retrieving from memory), storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and at least one of A, B, and C″ and at least one of A, B, or C″, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

Additionally, many implementations may be implemented in a processor, such as, for example, a post-processor or a pre-processor. The processors discussed in this application do, in various implementations, include multiple processors (sub-processors) that are collectively configured to perform, for example, a process, a function, or an operation. For example, the system 400 can be implemented using multiple sub-processors that are collectively configured to perform the operations of the system 400.

The implementations described herein may be implemented in, for example, a method or a process, an apparatus, a software program, a data stream, or a signal. Even if only discussed in the context of a single form of implementation (for example, discussed only as a method), the implementation of features discussed may also be implemented in other forms (for example, an apparatus or program). An apparatus may be implemented in, for example, appropriate hardware, software, and firmware. The methods may be implemented in, for example, an apparatus such as, for example, a processor, which refers to processing devices in general, including, for example, a computer, a microprocessor, an integrated circuit, or a programmable logic device.

Processors also include communication devices, such as, for example, computers, laptops, cell phones, tablets, portable/personal digital assistants (“PDAs”), and other devices that facilitate communication of information between end-users.

Implementations of the various processes and features described herein may be embodied in a variety of different equipment or applications. Examples of such equipment include an encoder, a decoder, a post-processor, a pre-processor, a video coder, a video decoder, a video codec, a web server, a television, a set-top box, a router, a gateway, a modem, a laptop, a personal computer, a tablet, a cell phone, a PDA, and other communication devices. As should be clear, the equipment may be mobile and even installed in a mobile vehicle.

Additionally, the methods may be implemented by instructions being performed by a processor, and such instructions (and/or data values produced by an implementation) may be stored on a processor-readable medium such as, for example, an integrated circuit, a software carrier or other storage device such as, for example, a hard disk, a compact diskette (“CD”), an optical disc (such as, for example, a DVD, often referred to as a digital versatile disc or a digital video disc), a random access memory (“RAM”), or a read-only memory (“ROM”). The instructions may form an application program tangibly embodied on a processor-readable medium. Instructions may be, for example, in hardware, firmware, software, or a combination. Instructions may be found in, for example, an operating system, a separate application, or a combination of the two. A processor may be characterized, therefore, as, for example, both a device configured to carry out a process and a device that includes a processor-readable medium (such as a storage device) having instructions for carrying out a process. Further, a processor-readable medium may store, in addition to or in lieu of instructions, data values produced by an implementation.

As will be evident to one of skill in the art, implementations may produce a variety of signals formatted to carry information that may be, for example, stored or transmitted. The information may include, for example, instructions for performing a method, or data produced by one of the described implementations. For example, a signal may be formatted to carry as data the rules for writing or reading syntax, or to carry as data the actual syntax-values generated using the syntax rules. Such a signal may be formatted, for example, as an electromagnetic wave (for example, using a radio frequency portion of spectrum) or as a baseband signal. The formatting may include, for example, encoding a data stream and modulating a carrier with the encoded data stream. The information that the signal carries may be, for example, analog or digital information. The signal may be transmitted over a variety of different wired or wireless links, as is known. The signal may be stored on a processor-readable medium.

A number of implementations have been described. Nevertheless, it will be understood that various modifications may be made. For example, elements of different implementations may be combined, supplemented, modified, or removed to produce other implementations. Additionally, one of ordinary skill will understand that other structures and processes may be substituted for those disclosed and the resulting implementations will perform at least substantially the same function(s), in at least substantially the same way(s), to achieve at least substantially the same result(s) as the implementations disclosed. Accordingly, these and other implementations are contemplated by this application.

1. A method comprising:
accessing a first portion in a video, and a second portion in the video;
determining a weight for the first portion;
determining a weight for the second portion;
determining a first number, the first number identifying how many pictures from the first portion are to be used in a pictorial summary of the video, wherein the first number is one or more, and is determined based on the weight for the first portion; and
determining a second number, the second number identifying how many pictures from the second portion are to be used in the pictorial summary of the video, wherein the second number is one or more, and is determined based on the weight for the second portion.

2. The method of claim 1 wherein:
determining the first number is further based on a value for total number of pages in the pictorial summary.

3. The method of claim 2 wherein the value for total number of pages in the pictorial summary is a user-supplied value.

4. The method of claim 1 further comprising:
accessing a first picture within the first portion and a second picture within the first portion;
determining a weight for the first picture based on one or more characteristics of the first picture;
determining a weight for the second picture based on one or more characteristics of the second picture; and
selecting, based on the weight of the first picture and the weight of the second picture, one or more of the first picture and the second picture to be part of the first number of pictures from the first portion that are used in the pictorial summary.

5. The method of claim 4 wherein selecting one or more of the first picture and the second picture comprises selecting a picture with a higher weight before selecting a picture with a lower weight.

6. The method of claim 4 wherein selecting one or more of the first picture and the second picture comprises selecting one or fewer pictures per shot in the first portion.

7. The method of claim 4 wherein the one or more characteristics of the first picture comprises signal-to-noise ratio, sharpness level, color harmonization level, or aesthetic level.

8. The method of claim 1 further comprising:
selecting one or more pictures from the video for inclusion in the pictorial summary; and
providing the pictorial summary.

9. The method of claim 8 wherein providing the pictorial summary comprises one or more of (i) presenting the pictorial summary, (ii) storing the pictorial summary, or (iii) transmitting the pictorial summary.

10. The method of claim 1 wherein:
determining the first number is based on a proportion of (i) the weight for the first portion and (ii) a total weight of all weighted portions.

11. The method of claim 10 wherein determining the first number is based on a product of (i) a user-supplied value for total number of pages in the pictorial summary and (ii) the proportion of the weight for the first portion and the total weight of all weighted portions.

12. The method of claim 1 wherein determining the first number is based on a user-supplied value for total number of pages in the pictorial summary.

13. The method of claim 1 wherein:
when the weight for the first portion is higher than the weight for the second portion, then the first number is at least as large as the second number.

14. The method of claim 1 wherein determining a weight for the first portion is based on input from a script corresponding to the video.

15. The method of claim 1 wherein determining a weight for the first portion is based on one or more of (i) a prevalence in the first portion of one or more main characters from the video, (ii) a length of the first portion, (iii) a quantity of highlights that are in the first portion, or (iv) a position of the first portion in the video.

16. The method of claim 15 wherein:
the prevalence in the first portion of one or more main characters from the video is based on a number of appearances in the first portion of main characters from the video.

17. The method of claim 16 wherein:
main characters are indicated by a higher appearance frequency over the video, and
the prevalence in the first portion of a first main character is determined, at least in part, by multiplying (i) an appearance frequency over the video of the first main character and (ii) a number of occurrences in the first portion of the first main character.

18. The method of claim 17 wherein:
an appearance frequency over the video for the first main character is based on a number of appearances over the video of the first main character divided by a total number of appearances over the video for all characters.

19. The method of claim 15 wherein a highlight includes one or more of a highlight action or a highlight object.

20. The method of claim 1 wherein the portion of the video is a scene, a shot, a group of scenes, or a group of shots.

21. The method of claim 1 wherein:
determining the weight for the first portion is based on user input.

22. The method of claim 1 further comprising:
determining whether to represent the first portion in the pictorial summary by comparing the weight for the first portion with respective weights of other portions of the video.

23. The method of claim 1 further comprising:
accessing one or more parameters from a configuration guide that includes one or more parameters for configuring the pictorial summary of the video; and
generating the pictorial summary for the video, wherein the pictorial summary conforms to the one or more accessed parameters from the configuration guide.

24. (canceled)

25. (canceled)

26. (canceled)

27. (canceled)

28. (canceled)
